(19) United States
(12) Patent Application Publication
(10) Pub. No.: US 2020/0269368 A1
(43) Pub. Date: Aug. 27, 2020

(54) TOOL CARRIER AND TOOL HOLDER

(71) Applicant: Karl-Heinz Schumacher, Reutlingen (DE)

(72) Inventor: Karl-Heinz Schumacher, Reutlingen (DE)

(21) Appl. No.: 16/799,340

(22) Filed: Feb. 24, 2020

(30) Foreign Application Priority Data
Feb. 25, 2019 (DE) 102019104686.6

(51) Int. Cl. B23Q 1/26

(52) U.S. Cl. CPC B23Q 1/26

(57) ABSTRACT

In order to improve a tool carrier of a machine tool, including a tool holder carrier with a receptacle that extends into the tool holder carrier and into which a fixing body of a tool holder is configured to be inserted, by moving it in an insertion direction, and immobilised in an inserted condition by fixing it in the receptacle by a positively locking element such that fixing of the fixing body is configured to be performed as simply and rapidly as possible, it is proposed that the positively locking element should be a fixing wedge-shaped body that is movable within the tool holder carrier, in a direction of movement transverse to the insertion direction, between a release position and a fixing position, and that, in the fixing position, the fixing wedge-shaped body should cooperate with a wedge receptacle of the fixing body.

### CROSS-REFERENCE TO RELATED PATENT APPLICATION

This patent application claims the benefit of German application No. 10 2019 104 686.6 filed Feb. 25, 2019, the teachings and disclosure of which are hereby incorporated in their entirety by reference thereto.

### BACKGROUND OF THE INVENTION

The invention relates to a tool carrier of a machine tool, including a tool holder carrier with a receptacle that extends into the tool holder carrier and into which a fixing body of a tool holder is configured to be inserted, by moving it in an insertion direction, and immobilised in an inserted condition by fixing it in the receptacle by a positively locking element.

Tool carriers of this kind are known from the prior art.

However, these have the problem that fixing the fixing body using the positively locking element is a complicated procedure.

The object of the invention is thus to improve a tool carrier of the type mentioned in the introduction such that fixing of the fixing body is configured to be performed as simply and rapidly as possible.

### SUMMARY OF THE INVENTION

This object is achieved according to the invention in the case of a tool carrier of the type mentioned in the introduction in that the positively locking element is a fixing wedge-shaped body that is movable within the tool holder carrier, in a direction of movement transverse to the insertion direction, between a release position and a fixing position, and in that, in the fixing position, the fixing wedge-shaped body cooperates with a wedge receptacle of the fixing body in order to fix the fixing body.

The advantage of the solution according to the invention can be seen in the fact that a fixing wedge-shaped body of this kind can be moved simply, and thus provides the possibility of immobilising or releasing the fixing body in the receptacle by simply moving the fixing wedge-shaped body between the release position and the fixing position and cooperating with the wedge receptacle in the fixing body, wherein the use of a wedge-shaped body allows large forces to be generated for the purpose of fixing the fixing body.

In principle, the fixing wedge-shaped body could be movable between the release position and the fixing position on a curved path.

However, a particularly simple possibility for operation provides for the fixing wedge-shaped body to be movable linearly in the tool holder carrier and to act on a wedge surface of the wedge receptacle of the fixing body by means of a fixing wedge surface.

More detailed statements have likewise not been made as regards guiding the fixing wedge-shaped body.

An advantageous solution provides for the fixing wedge-shaped body to be movably guided in a guide channel in the tool holder carrier.

In principle, the guide channel may extend within the tool holder carrier in various directions.

A particularly advantageous solution provides for the guide channel to penetrate into the receptacle transversely to the insertion direction, preferably to pass through it transversely to the insertion direction, and thus, in a simple manner, to provide the possibility of moving the fixing wedge-shaped body guided therein between the fixing position and the release position.

More detailed statements have not yet been made as regards the form taken by the fixing wedge-shaped body, in particular support thereof.

Here, an advantageous solution provides for the fixing wedge-shaped body to have, on a side opposite the fixing wedge surface, a support surface by means of which it is guided such that it is supported in the guide channel, at least in the fixing position.

A particularly favourable solution provides, in the fixing position, for the fixing wedge-shaped body to be supported in the guide channel by its support surface on both sides of the receptacle, wherein in particular in this case the guide channel passes through the receptacle transversely to the insertion direction.

This solution has the great advantage that in this case, in the fixing position, the fixing wedge surface of the fixing wedge-shaped body that acts on the fixing body lies between the positions at which the fixing wedge-shaped body is supported against the guide channel on both sides of the receptacle, with the result that the fixing wedge-shaped body is in a position to take up large forces and to apply large clamping forces to the fixing body, since these forces can be transmitted to the guide channel, and thus to the tool holder carrier, by the fixing body on both sides of the receptacle.

A further advantageous solution provides for the fixing wedge surface of the fixing wedge-shaped body to extend in a plane that forms an acute angle with a guide direction of the fixing wedge-shaped body that is movable in the guide channel, with the result that when the fixing wedge-shaped body is displaced in the guide direction the fixing wedge surface extends obliquely to the guide direction and can thus act on the fixing body, in particular the wedge surface of the fixing body, in a simple manner and can apply large forces to the fixing body in the fixing position.

In the context of the above description of the solution according to the invention, there has not yet been any detailed discussion of how the fixing wedge-shaped body is to be moved between the fixing position and the release position, and how the fixing wedge-shaped body is to be positioned in defined manner in the fixing position and the release position.

Here, an advantageous solution provides for the fixing wedge-shaped body to be movable between the fixing position and the release position by a positioning unit and to be positionable both in the fixing position and in the release position by means of the positioning unit.

In principle here, the positioning unit could be arranged directly next to the receptacle.

In order to achieve sufficient overall space, it is preferably provided for the positioning unit to be arranged on the tool holder carrier on a side remote from a front side of the tool holder carrier that faces the workpiece.

More detailed statements have not yet been made as regards the operation and form taken by the positioning unit itself.

In principle, a hydraulically operated or motorised positioning unit is possible.

A particularly simple and favourable solution provides for the positioning unit to be manually actuable for the purpose of moving the fixing wedge-shaped body between the fixing position and the release position and for the purpose of immobilising the fixing body in the fixing position.

Thus, a solution that is actuable in a simple manner, in particular manually, provides for the positioning unit to have a bayonet structure by means of which the fixing wedge-shaped body is positionable in both the fixing position and the release position.

The advantage of this solution is that a bayonet structure provides the possibility of unambiguously defining two positions that are spaced from one another in a displacement direction, one being associated with the fixing position and one with the release position, such that the fixing wedge-shaped body is configured on the one hand to be immobilised in these positions and on the other to be displaced between these positions in a simple manner in order to change rapidly from the fixing position to the release position or from the release position to the fixing position.

Preferably, the positioning unit takes a form such that it has a flanged body with bayonet flanges that cooperate with a bayonet contour of a guide sleeve.

In particular here, the bayonet contour takes a form such that it has two support surfaces that are spaced from one another in a displacement direction and rotated by an angle in relation to one another about an axis parallel to the displacement direction, wherein these two support surfaces serve to predetermine defined positions for the release position and substantially also the fixing position.

Moreover, it is advantageously provided for the flanged body with the bayonet flanges to be connected to a centring body that is guided in the guide sleeve, displaceably in the displacement direction.

Preferably in this case, a coupling is made between the centring body and the fixing wedge-shaped body such that, by displacing the centring body in the guide sleeve, the fixing wedge-shaped body is displaced and, by in each case immobilising the centring body with the bayonet flanges of the bayonet structure, the fixing wedge-shaped body can be positioned both in the release position and also in a starting position for the fixing position.

In principle, it would be conceivable to connect the centring body and the fixing wedge-shaped body to one another rigidly.

With this solution, however, the problem would arise that the fixing wedge-shaped body would not be able to apply a clamping force to the fixing body in the fixing position.

For this reason, an advantageous solution provides for the fixing wedge-shaped body to be coupled adjustably to the positioning unit, in particular to the centring body of the positioning unit.

This provides the possibility of using the positioning unit to position the fixing wedge-shaped body in the release position and the starting position for the fixing position by means of the bayonet structure, while still being able to move the fixing wedge-shaped body in relation to the positions predetermined by the positioning unit, at least in the fixing position.

A particularly advantageous solution provides for the centring body to be coupled to the fixing wedge-shaped body by means of an adjusting screw that is screwed to the centring body.

In particular here, the adjusting screw is screwed into the centring body.

An adjusting screw of this kind thus makes it possible, at least in the fixing position, still to carry out a relative positioning of the fixing wedge-shaped body in relation to a starting position that is predetermined by the bayonet flanges and the one support surface.

The positioning unit thus for example enables the fixing body to be moved in this way such that it can first be moved, without significant application of force, from the release position into the starting position for the fixing position, in which the fixing wedge-shaped body does not yet cooperate with the fixing body without play.

Once the starting position for the fixing position, defined by the bayonet flange and the support surface of the bayonet contour, has been reached, the adjusting screw provides the possibility of moving the fixing wedge-shaped body further until it acts on the fixing body of the tool holder with a force that has a component in the insertion direction, in order to move the fixing body into a defined final position in the receptacle and to hold it there by the application of force.

A particularly favourable solution provides for the tool holder carrier to have a bearing side on which the tool holder is placeable, in particular being supportable against it, in order to connect the tool holder to the tool holder carrier with the required stability.

Here, it is particularly favourable if the tool holder carrier is provided on the bearing side with first positively locking elements that extend in particular transversely to a feed direction of the tool holder carrier.

Positively locking elements of this kind have the advantage of being able to take up forces in the feed direction.

In particular, a solution of this kind provides for the receptacle to extend from the bearing side into the tool holder carrier, with the result that, when the fixing wedge-shaped body acts on the fixing body in the receptacle, the tool holder can be held in abutment against the bearing side by the application of force and thus the positively locking elements can also cooperate with the tool holder by the application of force.

The invention furthermore relates to a tool holder for fixing to a tool carrier in particular according to one or more of the preceding features, wherein the tool holder has a fixing body that is insertable into the receptacle of the tool carrier.

Here, the fixing body may take the most diverse forms.

In particular here, it is provided for the fixing body, as the wedge receptacle, to have an aperture in which there is provided a wedge surface on which a fixing wedge-shaped body of the tool carrier acts in the fixing position by means of a fixing wedge surface, in order to fix the tool holder on the tool carrier.

Moreover, it is preferably provided for the tool holder to have a support body that is placeable on the bearing side of the tool holder carrier by means of a support surface.

It is particularly favourable if, starting from the support side of the support body, the fixing body extends away from the support body in order to be brought into engagement with the receptacle in a simple manner.

A further favourable solution provides for the support body to be provided, on the support side, with second positively locking elements that engage with first positively locking elements of the tool holder carrier when the tool holder is fixed to the tool holder carrier, wherein these positively locking elements in particular serve, during machining of a workpiece, to take up forces that act on the tool and hence on the tool holder and are to be transmitted to the tool holder carrier, such that these forces are not transmitted through the fixing body and the receptacle to the tool holder carrier.

As regards the forces to be taken up, it is particularly favourable if the second positively locking elements, in cooperation with the first positively locking elements, exactly position the tool holder in relation to the tool holder carrier in a feed direction, in particular in the X feed direction of the tool carrier, since exact positioning in the X feed direction is of primary importance for the accuracy of machining in a machine tool, in particular a lathe.

In order to achieve a construction that takes up the largest possible forces in the fixing position, it is advantageously provided for the fixing body to have a greater extent in a direction transverse to a direction of movement of the fixing wedge-shaped body than in the direction of movement.

Thus, the above description of solutions according to the invention includes in particular the different combinations of features that are defined by the consecutively numbered embodiments below:

1. A tool carrier of a machine tool, including a tool holder carrier (62) with a receptacle (64) that extends into the tool holder carrier (62) and into which a fixing body (72) of a tool holder (32) is configured to be inserted, by moving it in an insertion direction (74), and immobilised in an inserted condition by fixing it in the receptacle (64) by a positively locking element (118), wherein the positively locking element is a fixing wedge-shaped body (118) that is movable within the tool holder carrier (62), in a direction of movement (124) transverse to the insertion direction (74), between a release position and a fixing position, and in that, in the fixing position, the fixing wedge-shaped body (118) cooperates with a wedge receptacle (112, 114) of the fixing body (72).

2. A tool carrier according to embodiment 1, wherein the fixing wedge-shaped body (118) is movable linearly in the tool holder carrier (62) and acts on a wedge surface (114) of the wedge receptacle (112) of the fixing body (72) by means of a fixing wedge surface (116).

3. A tool carrier according to one of the preceding embodiments, wherein the fixing wedge-shaped body (118) is movably guided in a guide channel (122) in the tool holder carrier (62).

4. A tool carrier according to one of the preceding embodiments, wherein the guide channel (122) engages in the receptacle (64) transversely to the insertion direction (74).

5. A tool carrier according to one of the preceding embodiments, wherein the fixing wedge-shaped body (118) has, on a side opposite the fixing wedge surface (116), a support surface (126) by means of which it is guided such that it is supported in the guide channel (122), at least in the fixing position.

6. A tool carrier according to embodiment 5, wherein in the fixing position, the fixing wedge-shaped body (118) is supported in the guide channel (122) by its support surface (126) on both sides of the receptacle (64).

7. A tool carrier according to one of the preceding embodiments, wherein the fixing wedge surface (116) of the fixing wedge-shaped body (118) extends in a plane that forms an acute angle with a guide direction (124) of the fixing wedge-shaped body (118) that is movable in the guide channel (122).

8. A tool carrier according to one of the preceding embodiments, wherein the fixing wedge-shaped body (118) is movable between the fixing position and the release position by a positioning unit (180) and is positionable both in the fixing position and in the release position by means of the positioning unit (180).

9. A tool carrier according to embodiment 8, wherein the positioning unit (180) is arranged on the tool holder carrier (62) on a side remote from a front side (142) of the tool holder carrier (62) that faces the workpiece.

10. A tool carrier according to embodiment 8 or 9, wherein the positioning unit (180) is manually actuable for the purpose of moving the fixing wedge-shaped body (118) between the fixing position and the release position and for the purpose of immobilising the fixing body (118) in the fixing position.

11. A tool carrier according to one of embodiments 8 to 10, wherein the positioning unit (180) has a bayonet structure by means of which the fixing wedge-shaped body (118) is positionable in both the fixing position and the release position.

12. A tool carrier according to embodiment 11, wherein the positioning unit (180) has a flanged body (184) with bayonet flanges (186) that cooperate with a bayonet contour (188) of a guide sleeve (192).

13. A tool carrier according to embodiment 12, wherein the bayonet contour (188) has two support surfaces (194, 196) that are spaced from one another in a displacement direction (124) and rotated by an angle in relation to one another about an axis parallel to the displacement direction (124).

14. A tool carrier according to embodiment 12 or 13, wherein the flanged body (184) with the bayonet flanges (186) is connected to a centring body (204) that is guided in the guide sleeve (192), displaceably in the displacement direction (124).

15. A tool carrier according to one of the preceding embodiments, wherein the fixing wedge-shaped body (118) is coupled adjustably to the positioning unit (180), in particular to the centring body (204).

16. A tool carrier according to embodiment 15, wherein the centring body (204) is coupled to the fixing wedge-shaped body (118) by means of an adjusting screw (222) that is screwed to the centring body (204).

17. A tool carrier according to one of the preceding embodiments, wherein the tool holder carrier (62) has a bearing side (66) on which the tool holder (32) is placeable.

18. A tool carrier according to embodiment 17, wherein the tool holder carrier (62) is provided on the bearing side (66) with first positively locking elements (82) that extend in particular transversely to a feed direction (X) of the tool holder carrier (62).

19. A tool holder (32) for fixing to a tool carrier (30) in particular according to one of the preceding embodiments, wherein the tool holder (32) has a fixing body (72) that is insertable into the receptacle (64) of the tool carrier (30).

20. A tool holder according to embodiment 19, wherein the fixing body (72), as the wedge receptacle, has an aperture (112) in which there is provided a wedge surface (114) on which a fixing wedge-shaped body (118) of the tool carrier (30) acts in the fixing position by means of its fixing wedge surface (116).

21. A tool holder according to one of embodiments 19 or 20, wherein it has a support body (104) that is placeable on the bearing side (66) of the tool holder carrier (62) by means of a support surface (102).

22. A tool holder according to one of embodiments 19 to 21, wherein, starting from the support side (102) of the support body (104), the fixing body (72) extends away from the support body (104).

23. A tool holder according to one of embodiments 19 to 22, wherein the support body (104) is provided, on the support side (102), with second positively locking elements (92) that engage with first positively locking elements (82) of the tool holder carrier (62) when the tool holder (32) is fixed to the tool holder carrier (62).

24. A tool holder according to embodiment 23, wherein the second positively locking elements (92), in cooperation with the first positively locking elements (82), exactly position the tool holder (32) in relation to the tool holder carrier (62) in a feed direction (X) of the tool carrier (30).

25. A tool holder according to one of embodiments 19 to 24, wherein the fixing body (72) has a greater extent in a direction transverse to a direction of movement (124) of the fixing wedge-shaped body (118) than in the direction of movement (124).

Further features and advantages of the invention form the subject-matter of the description below and the representation in the drawing of some exemplary embodiments.

### BRIEF DESCRIPTION OF THE DRAWINGS

FIG. 1 shows a perspective detail illustration of a machine tool with tool carriers and workpiece spindles;

FIG. 2 shows a perspective illustration of a tool carrier, and mounted thereon a tool holder with a tool;

FIG. 3 shows an exploded illustration of the tool holder and the tool carrier in FIG. 2;

FIG. 4 shows a perspective illustration of the tool holder according to the invention, in particular in a view of a support side and a fixing body thereof;

FIG. 5 shows a perspective illustration of a tool carrier according to the invention, in a view of a bearing side thereof;

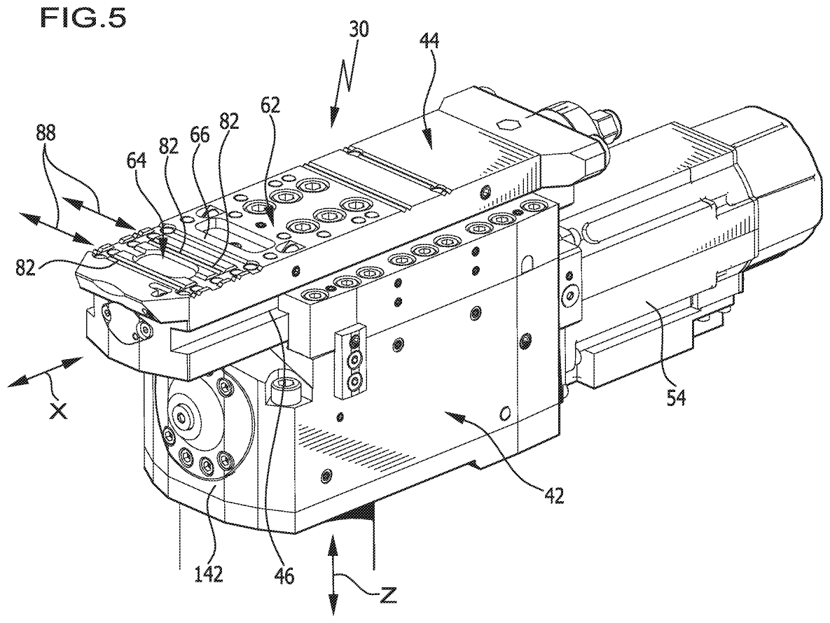

FIG. 6 shows a section through the tool carrier with the tool holder placed on, along the line 6-6 in FIG. 2;

FIG. 7 shows a section through the tool holder placed on the tool carrier, along the line 7-7 in FIG. 6;

FIG. 8 shows a section through the entire unit comprising the tool carrier and the tool holder, with a positioning unit and a fixing wedge-shaped body that is in the fixing position;

FIG. 9 shows a perspective exploded illustration of a positioning unit according to the invention;

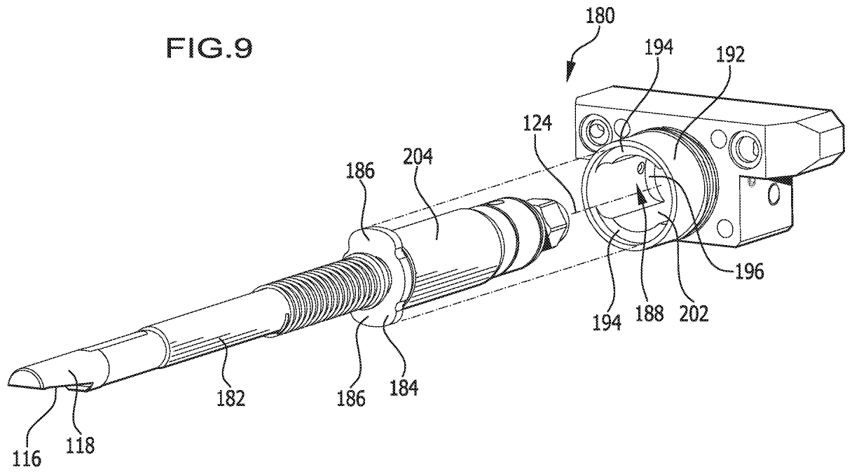

FIG. 10 shows a section similar to FIG. 8, with the fixing wedge-shaped body in the release position;

FIG. 11 shows an exploded illustration, similar to FIG. 3, of a tool carrier according to the invention, with a tool holder according to the invention and a further tool holder mounted on the tool carrier in addition to the tool holder according to the invention; and

FIG. 12 shows a perspective illustration, similar to FIG. 3, of a tool carrier according to the invention, with a further, non-inventive, conventional tool holder with a drive unit.

### DETAILED DESCRIPTION OF THE INVENTION

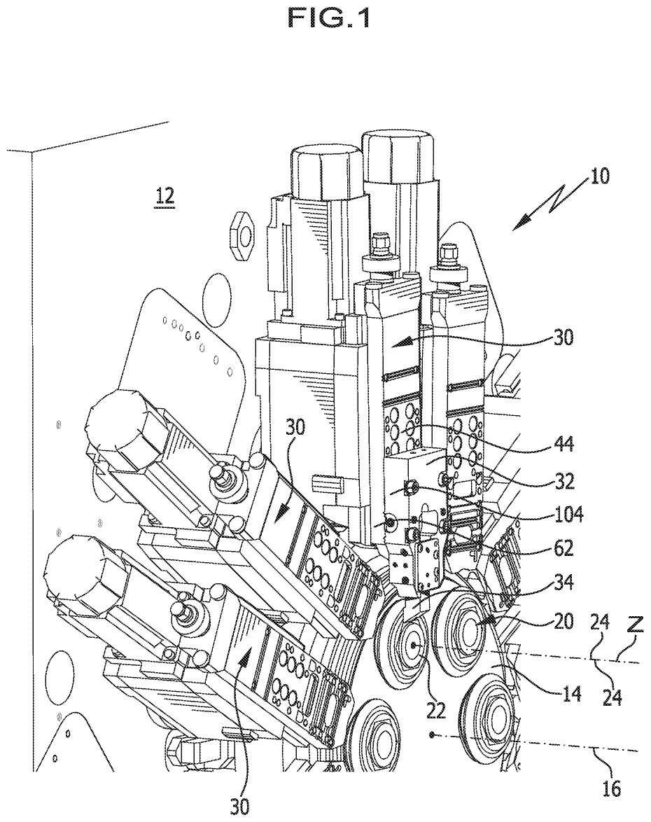

A machine tool 10, illustrated in FIG. 1, in particular a lathe, preferably, in the illustrated exemplary embodiment, a multi-spindle lathe, includes a machine frame, designated 12 as a whole, on which in the case of a multi-spindle machine a spindle drum 14 is mounted about a spindle drum axis 16.

In the case of a multi-spindle lathe, the spindle drum 14 itself carries a plurality of workpiece spindles 20, which are arranged at equal angular spacings relative to one another about the spindle drum axis 16.

By rotating the spindle drum 14 about the spindle drum axis 16, the individual workpiece spindles 20 are configured to be positioned in individual spindle stations, in which the workpieces 22 rotating about spindle axes 24 and received in the workpiece spindles 20 can be machined.

For the purpose of machining the workpieces 22 in the individual spindle stations, there are arranged on the machine frame tool carriers, designated 30 as a whole, that carry tool holders 32 with tools 34 that are held by these tool holders 32 (FIG. 1).

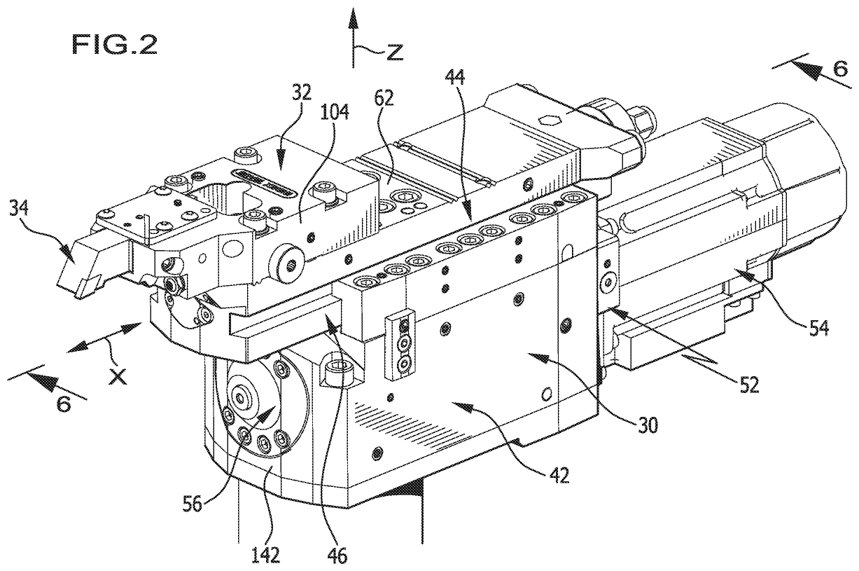

As illustrated in FIGS. 1 and 2, the tool carriers 30 take a form such that they are movable for example parallel to a Z axis—that is to say parallel to the spindle axis 24 of the workpiece spindles 20—and themselves have a tool carrier base 42 on which a tool carriage 44 is displaceably guided along a feed axis X by means of a carriage guide 46, wherein the axis X preferably extends radially in relation to the respective spindle axis 24 of the workpiece spindle 20 in the respective spindle station.

For the purpose of driving movements of the tool carriage 44 in the X direction, the tool carrier base 42 is provided with a carriage drive 52 that has a drive motor 54 which drives for example a spindle drive 56—arranged in the tool carrier base 42 and thus not visible in FIG. 2—by means of which the tool carriage 44 is displaced in the X direction.

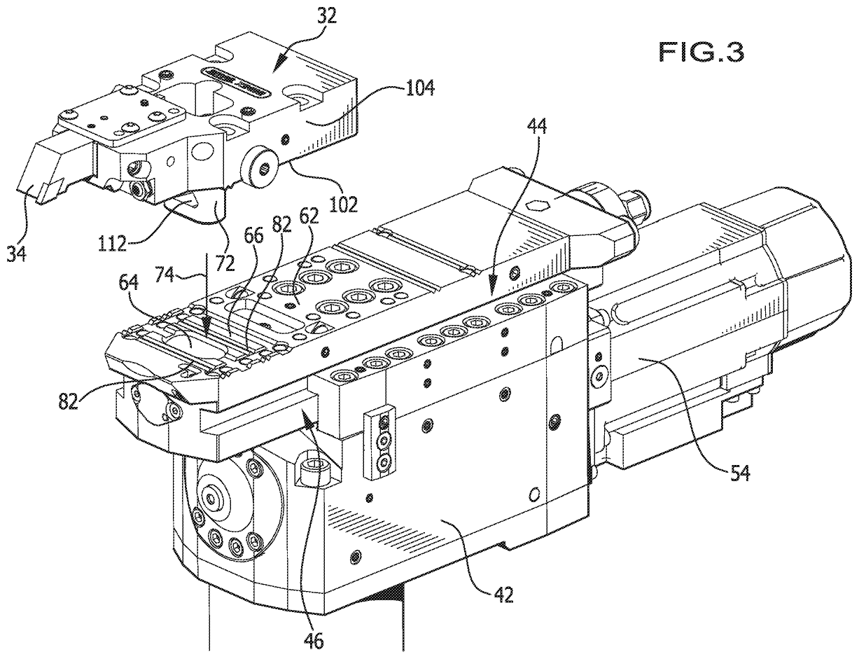

The tool carriage 44 itself includes a tool holder carrier 62 on which the tool holder 32 with the tool 34 is fixable—as illustrated in FIGS. 2 and 3.

For the purpose of receiving the tool holder 32, the tool holder carrier 62 is provided with a receptacle 64 that extends from a bearing side 66 of the tool holder carrier 62 for the tool holder 32 into the tool holder carrier 62 and serves to receive a fixing body 72 of the tool holder 32, wherein the fixing body 72 is movable into the receptacle 64 in an insertion direction 74 extending transversely to the bearing side 66, and is fixable in the receptacle 64, as described in detail below.

For the purpose of additionally stabilising the tool holder 64 in relation to the tool holder carrier 62, the tool holder carrier 62 is provided, in the region of its bearing side 66 and to the side of the receptacle 64, with first positively locking elements 82 that extend transversely and preferably perpendicular to the X direction and are provided in the bearing side 66, on both sides of the receptacle 64 in the X direction.

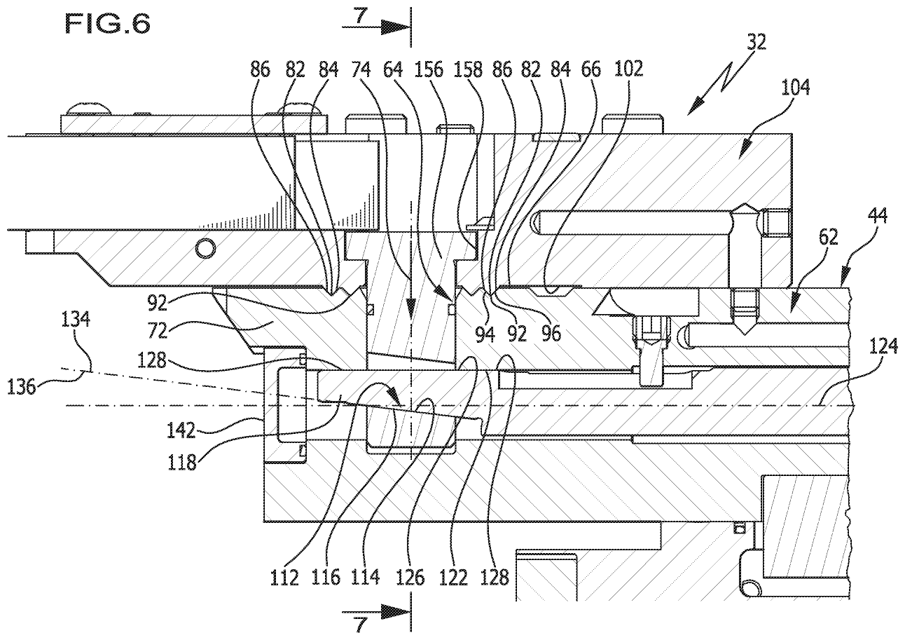

In this case, and as illustrated in FIG. 6, the first positively locking elements 82 have flank faces 84 and 86 that extend obliquely, in particular at an acute angle to the insertion direction 74 and preferably take the form of grooves that have mutually parallel directions of extent 88, wherein the directions of extent 88 themselves extend transversely and preferably perpendicular to the X direction.

Preferably, the flank faces 84 and 86 also extend at the same spacings from one another, with the result that, over their extent in the direction of extent 88, the positively locking elements 82 have a constant cross-sectional shape transverse to the directions of extent 88.

Second positively locking elements 92 cooperate with the first positively locking elements 82 arranged on the bearing side 66, and take a form complementary to the first positively locking elements 82 and have flank faces 94 and 96 that are configured to be brought into abutment with the flank faces 84 and 86 of the first positively locking elements 82 (FIG. 6).

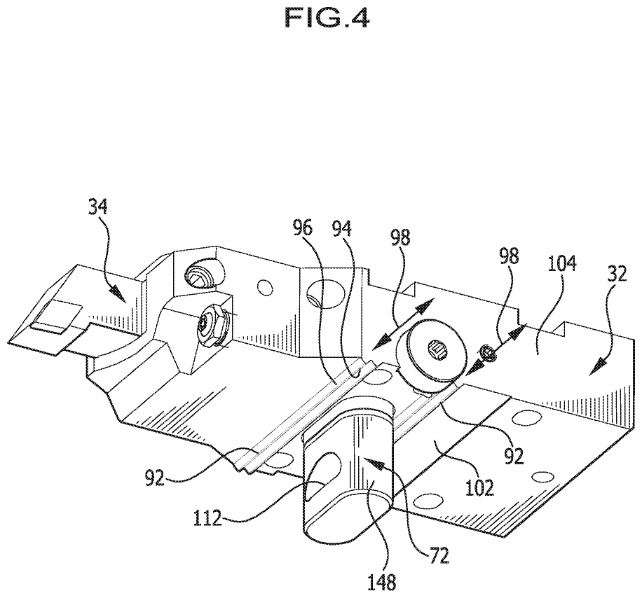

These second positively locking elements 92 likewise extend with their directions of extent 98 parallel to the directions of extent 88 of the first positively locking elements, and are arranged on a support side 102 of a support body 104 of the tool holder 32 (FIGS. 4, 6).

Preferably, the positively locking elements 82, 92 take a form as described in EP 1 514 623 A1, which is incorporated herein by reference in its entirety.

Here, the fixing body 72 is likewise arranged between the second positively locking elements 92 and extends from the support side 102 of the support body 104 and away from the support body 104.

When the support side 102 of the support body 104 of the tool holder 32 is placed on the bearing side 66 of the tool holder carrier 62, the first positively locking elements 82 and the second positively locking elements 92 engage in one another, and these have the effect of fixing the support body 104 in relation to the tool holder carrier 62 to prevent displacement in the X direction and at the same time to prevent rotation about a potential axis of rotation extending parallel to the insertion direction 72.

Thus, the positively locking elements 82 and 92 already fix the support body 104 of the tool holder 32 by positive locking to prevent movement in the X direction, with the result that the only movement still permitted by the first and second positively locking elements 82, 92 would be in the direction of the directions of extent 88 and 98.

However, such movements of the support body 104 in relation to the tool holder carrier 62 are prevented by the fact that the fixing body 72 is forcibly drawn into the receptacle 64 of the tool holder carrier 62 and fixing is thus performed by force-locking between the tool holder carrier 62 and the support body 104 in particular to prevent movements transverse to the X direction, as explained in detail below.

For the purpose of immobilising the fixing body 72 in the receptacle 64 of the tool holder carrier 62, and for the purpose of generating a force acting in the insertion direction 74 for urging the support body 104 of the tool holder 32 in the direction of the tool holder carrier 62, the fixing body 72 is provided with an aperture 112 that extends through the fixing body 72 transversely to the insertion direction 74 (FIG. 4 and FIG. 6), wherein the aperture 112 has a wedge surface 114 that extends transversely to the insertion direction 74, on an opposite side to the support body 104.

For the purpose of fixing the fixing body 72 in the receptacle 64, the wedge surface 114 cooperates with a fixing wedge surface 116 of a fixing wedge-shaped body 118 that is insertable into the aperture 112.

Here, the fixing wedge-shaped body 118 is guided in a guide channel 122 in the tool holder carrier 62, wherein the guide channel 122 extends transversely, preferably perpendicular, to the receptacle 64 in the tool holder carrier 62 and passes through the receptacle 64 and thus extends on both sides of the receptacle 64.

In this arrangement, the guide channel 122 defines a guide direction 124 along which the fixing wedge-shaped body 118 is movable.

Here, the fixing wedge-shaped body 118 takes a form such that, when the fixing wedge surface 116 acts on the wedge surface 114 of the fixing body 72, and urges the fixing body 72 with a force acting in the insertion direction 74, the fixing wedge-shaped body 118 is supported in the guide channel 122, on both sides of the receptacle 64 in support regions 128 that are adjacent to the receptacle 64, by means of a bearing side 126 opposite the fixing wedge surface 116, such that the fixing wedge surface 116 acting on the wedge surface 114 lies between these two support regions 128, and it is thus possible for large forces to act on the wedge surface 114 as a result of the support on both sides of the fixing wedge-shaped body 118.

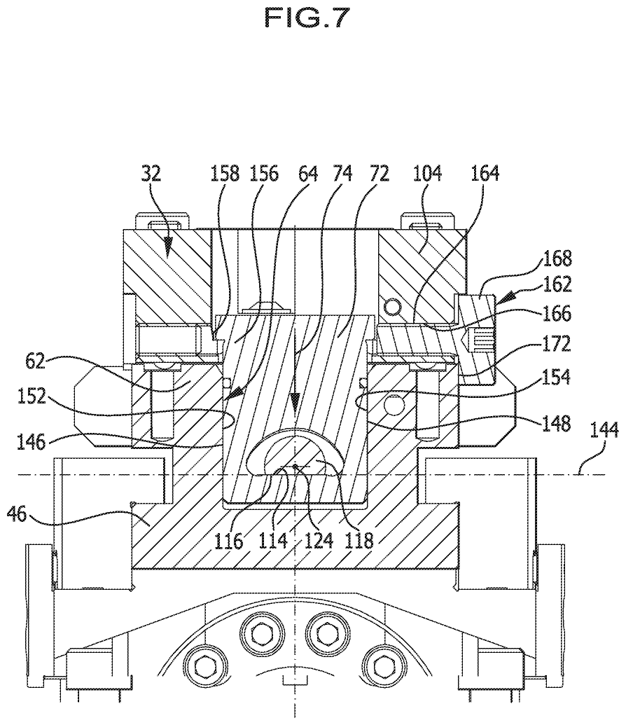

Preferably, as illustrated in FIGS. 6 and 7, the shapes of the wedge surface 114 and the fixing wedge surface 116 are matched to one another such that they abut against each other flat, with the largest possible bearing surface.

In the simplest case, when the wedge surface 114 and the fixing wedge surface 116 cooperate, they extend in coincident and mutually parallel planes 134 and 136 respectively, which on the one hand form an acute angle with the guide direction 124 and extend as far as the insertion direction 74.

Preferably, the mutually parallel planes 134, 136 that coincide when the wedge surface 114 and the fixing wedge surface 116 are cooperating are oriented such that, because they form an acute angle with the guide direction 124, as their spacing from a front side 142 of the tool holder carrier 62 that faces the respective workpiece spindle 20 and thus the workpiece increases, so too does their spacing from the bearing side 66, and moreover they extend parallel to a transverse direction 144 that extends perpendicular to the insertion direction 74 and the guide direction 124, wherein the transverse direction 144 is itself preferably oriented parallel to the bearing side 66 and preferably also parallel to the X direction (FIG. 7).

As illustrated in FIGS. 4, 6 and 7, the fixing body 72 has transverse side faces 146 and 148 that extend parallel to the insert direction 74 and abut against the corresponding transverse guide faces 152 and 154 of the receptacle 64 and, with these, bring about transverse fixing of the fixing body 72 to prevent movement in the transverse direction 144. The support body 104 and consequently also the tool holder 32 are movable to a limited extent in relation to the fixing body 72, for example in the direction parallel to the transverse direction 144 and thus also parallel to the directions of extent 88 and 98 of the first and second positively locking elements 82, 92, since the fixing body 72 is held with play, by means of a T-shaped head 156, in a receptacle 158 in the support body 104, at least in the direction parallel to the transverse direction 144.

In order to utilise the fact that the support body 104 is movable in the transverse direction 144 as a result of the play between the support body 104 and the fixing body 72, for the purpose of exactly orienting the support body 104 in relation to the workpiece 22, there is also provided an orienting screw 162, which engages by means of its threaded portion 164 in a threaded bore 166 extending parallel to the transverse direction 144 in the support body 104 and which is configured to abut by means of its head 168 against an orienting face 172 of the tool holder carrier 62, in order to position the support body 104 precisely in relation to the tool holder carrier 62, for example by bringing the transverse face 148 into abutment with the guide face 154.

Fixing of the support body 104 in relation to the tool holder carrier 62 is performed by force locking between the support side 102 of the support body 104 and the bearing side 66 of the tool holder carrier 62, wherein the force with which the support side 102 acts on the bearing side 66 is generated by the action of the fixing wedge-shaped body 118 on the fixing body 72.

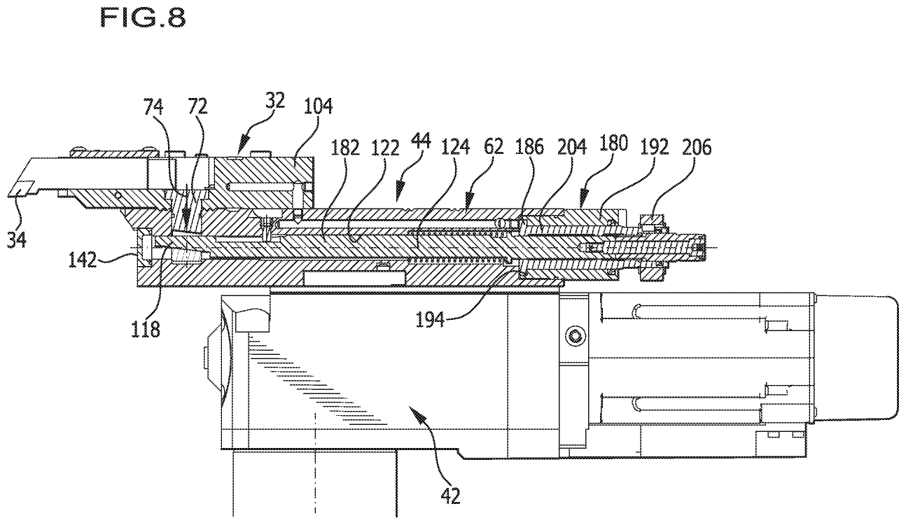

In the exemplary embodiment illustrated, the guide channel 122 extends from the receptacle 64 as far as a positioning unit 180 for the wedge-shaped body 118, wherein a displacement body 182 that extends to prolong the wedge-shaped body 118 extends in the guide channel 122 connecting the wedge-shaped body 118 to the positioning unit 180 (FIG. 8).

The positioning unit 180 is preferably configured to be actuated manually. It includes a bayonet structure, which is formed by a flanged body 184 extending transversely to the guide direction 124 and provided with mutually opposing bayonet flanges 186, which cooperate with a bayonet contour 188 that is formed on an inner side of a guide sleeve 192 and has front support surfaces 194, which are spaced from one another in the guide direction 124 and against which the bayonet flanges 186 abut when the fixing wedge-shaped body 118 is to be in the fixing position, and rear support surfaces 196, against which the bayonet flanges 186 abut when the fixing wedge-shaped body 118 is to be in a release position in which the fixing wedge-shaped body 118 does not engage in the aperture 112 and does not abut against the wedge surface 114 but is retracted far enough within the guide channel 122 for the latter not to engage in the receptacle 64 either.

In this arrangement, the support surfaces 194 and 196 are arranged rotated for example through 90° in relation to one another.

Further, the guide sleeve 192 also forms, parallel to the guide direction 124, guide faces 202 on which a centring body 204 that adjoins the flanged body 184 on an opposite side to the fixing wedge-shaped body 118 is guided movably in the guide direction 124, wherein the centring body 204 is firmly connected to the flanged body 184 carrying the bayonet flanges 186 and surrounds the displacement body 182.

For the purpose of displacing and turning the flanged body 184 with the bayonet flanges 186, on a side of the guide sleeve 192 remote from the flanged body 184 the centring body 204 carries an actuating element 206 that takes the form for example of a manual actuating element and makes it possible to displace the centring body 204, together with the flanged body 184 and the bayonet flanges 186, in relation to the guide sleeve 192 and to turn it about an axis parallel to the guide direction 124 such that the bayonet flanges 196 come into abutment either against the front support surfaces 194 or the rear support surfaces 196.

In order that the bayonet flanges 186 abut against the respective support surfaces 194 and 196, and in order that the bayonet flanges 186 are thus kept in abutment against the support surfaces 194, 196, there is preferably also provided a pressure spring 208 that is supported at one end against a step 212 or shoulder in the guide channel 122 and at the other against a collar 214 of the displacement body 182 and thus strives to move the displacement body 182, and with it also the centring body 204 coupled to it, from the fixing position towards the release position.

The displacement body 182 is connected, by way of an adjusting screw 222 rotatably connected to it, to the centring body 204 in that an external thread 224 of the adjusting screw 222 engages in an internal thread 226 in the centring body 204, and in this way the displacement body 182 is configured to be positioned in a defined manner relative to the centring body 204.

This has the result that, under the action of the pressure spring 208, the centring body 204 with the bayonet flanges 186 fixedly connected to it is urged from the fixing position towards the release position, so the bayonet flanges 186 are always kept in abutment against either the rear support surfaces 196 corresponding to the release position, or the front support surfaces 194 predetermining a starting position for the fixing position.

Further, the adjusting screw 222 allows the fixing wedge-shaped body 118 to be positioned adjustably in relation to the starting position for the fixing position.

It is thus possible to use the positioning unit 180 to position the fixing wedge-shaped body 118 in the fixing position in relation to the tool holder carrier 62 and thus also to position it in relation to the fixing body 72 located in the receptacle 64, and thus to enable adjustable positioning of the fixing wedge surface 116 of the fixing wedge-shaped body 118 in relation to the wedge surface 114 of the fixing body 72 and, as a result of such positioning of the fixing wedge-shaped body 118 in relation to the fixing body 72, to have the effect that the fixing wedge-shaped body 118 applies a force acting in the direction of the insertion direction 74 to the fixing body 72 such that the first and second positively locking elements 82 and 92 are held in abutment without play.

The fixing body 72 of the tool holder 32, and the fixing wedge-shaped body 118 that is arranged movably on the tool holder carrier 62, with the positioning unit 180 thus form a quick-clamping device for the tool carrier 30.

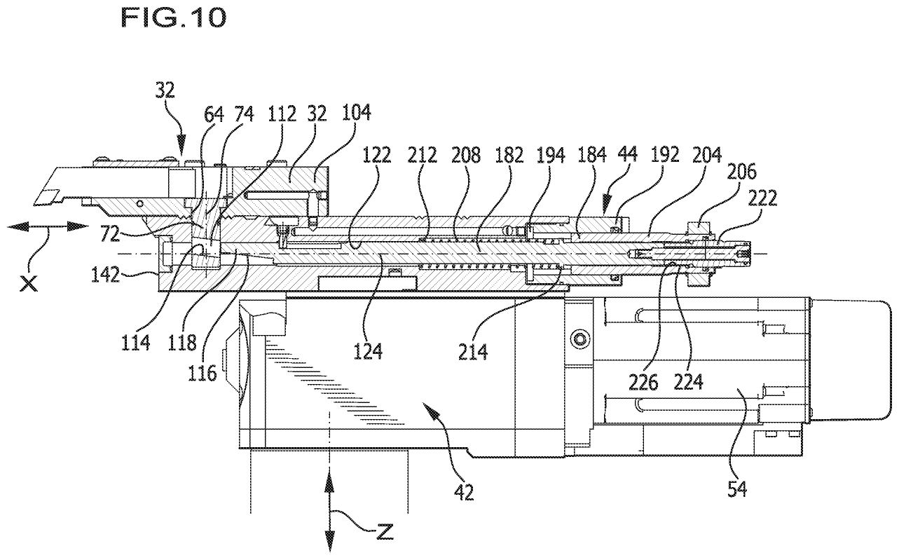

For the purpose of moving the fixing wedge-shaped body 118 from the release position, illustrated by way of example in FIG. 10, to the fixing position, illustrated by way of example in FIG. 8, manual intervention on the actuating element 206 produces a displacement thereof in the direction of the guide direction 124 towards the front side 142, such that the bayonet flanges 186 are lifted away from the rear support surfaces 196 and likewise move towards the front side 142 until they are at the level of the front support surfaces 194, with the result that turning the centring body 204 allows the flanged bodies 184 to be brought into abutment against the front support surfaces 194 of the guide sleeve 192 and to predetermine the starting position for the fixing position.

In this arrangement, the bayonet flanges 186 are urged by the pressure spring 208.

This displacement of the centring body 204 at the same time results in displacement of the fixing wedge-shaped body 118 such that it engages in the aperture 112 in the fixing body 72 and acts, by means of the fixing wedge surface 116, on the wedge surface 114 of the fixing body 72.

However, in this position the fixing body 72 is not yet clamped in the receptacle 64.

The final clamping of the fixing body 72 in the receptacle 64 is performed by turning the adjusting screw 222, which is rotatably connected to the displacement body 184, such that a small further displacement of the fixing wedge-shaped body 118 results in clamping of the fixing body 72 in the receptacle 64, with the result that the fixing wedge-shaped body 118 is supported on one side with the two support regions 128 in the guide channel 122 and on the other with the fixing wedge surface 116 acting on the wedge surface of the fixing body 72 and thus urging it in the direction of the insertion direction 74 with a force that at the same time causes the positively locking elements 82 and 92 to abut against one another by the application of force.

For the purpose of release of the fixing of the fixing body 72, the adjusting screw 222 is turned again in the opposite direction, with the result that the clamping between the fixing wedge-shaped body 118 and the fixing body 72 is released.

In this position, it is again possible, by means of manual action on the actuating element 206, to turn the flanged body 184 with the bayonet flanges 186 by turning the centring body 204, such that the bayonet flanges 186 are released from the front support surfaces 194 and, once they have been released from these front support surfaces 184, are moved, urged by the pressure spring 208, towards the rear support surfaces 196 and then held in abutment against the rear support surfaces by the pressure spring 208.

In this way, the pressure spring 208 then holds the fixing wedge-shaped body 118 in the release position.

As a result, the quick-clamping device according to the invention makes it possible to fix the tool holder 32 in relation to the tool holder carrier 62 quickly and simply, and on the other hand to position the tool holder 32 precisely in relation to the tool holder carrier 62.

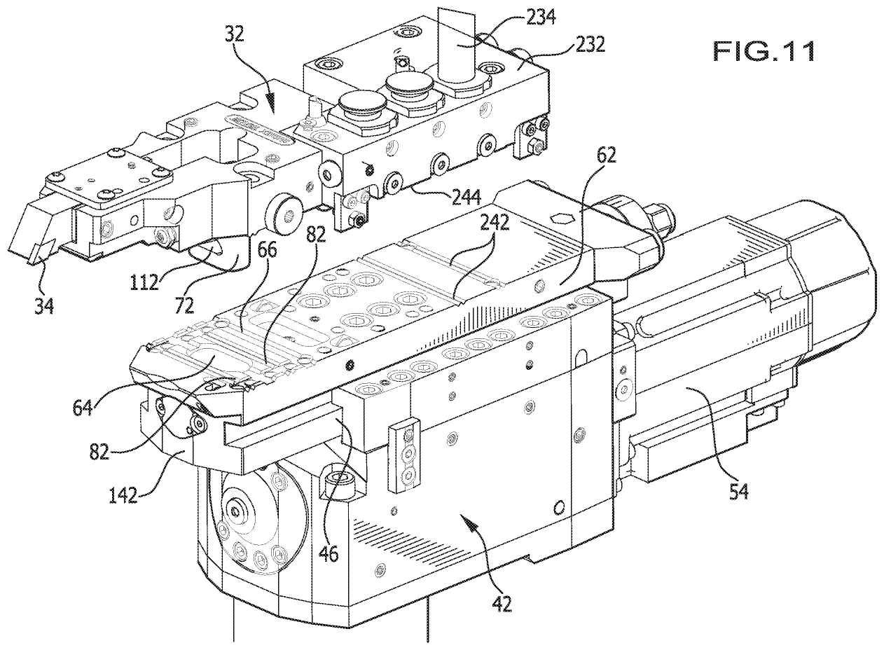

In a variant of the first exemplary embodiment, illustrated in FIG. 11, not only is the tool holder 32 with the tool 34 mountable on the tool holder carrier 62 but so is an additional tool holder 232 that carries for example a tool 234 for machining the rear side of a workpiece held by a counter-spindle.

Here, the mounting of the second tool holder 232 is performed not by way of the fixing body 72 but in conventional manner, by means of screws that are configured to be screwed into the tool holder carrier 62 transversely to the bearing side 66.

Further, in addition, for the purpose of exact positioning of the second tool holder 232, there are likewise provided positively locking elements 242 that cooperate with positively locking elements 244 likewise arranged on the second tool holder 232 (FIG. 11).

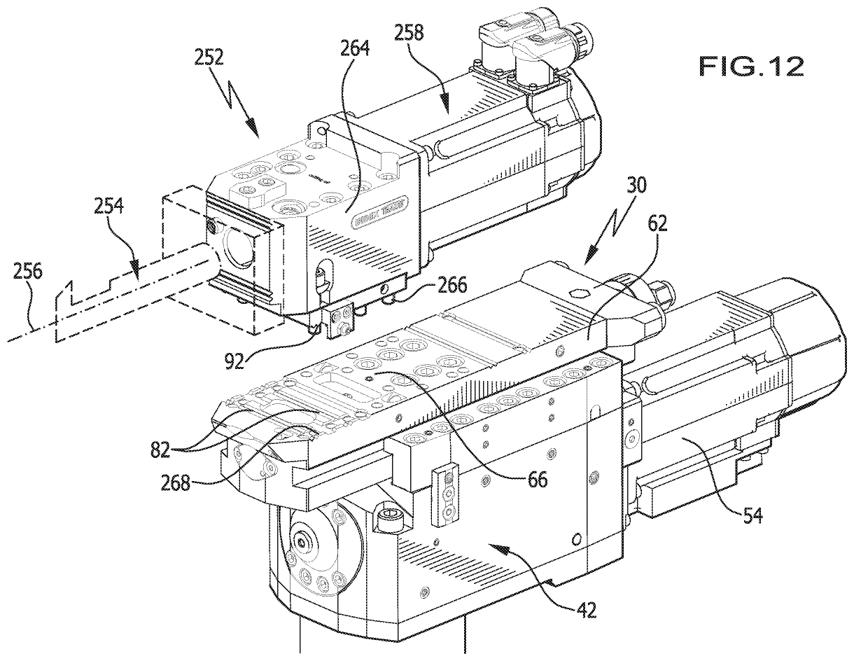

In a further variant of the solution according to the invention, a driven tool holder that is designated 252 as a whole is mountable on the tool carrier 30 according to the invention, wherein this driven tool holder carries a tool 254 (illustrated in dashed lines) that is drivable in rotation about an axis 256 (FIG. 12).

For driving the tool 254 in rotation, there is provided a drive motor that is designated 258 as a whole and is flanged to a support body 264 of the third tool holder 252.

The support body 264 is itself provided with positively locking elements 92 that cooperate with the positively locking elements 82 on the support side 66 of the tool holder carrier 62, wherein in this case the support body 104 is likewise fixed to the tool holder carrier 62 in conventional manner by screws 266 that engage in corresponding screw holes 268 in the tool holder carrier 62.

This means that in this variant the third tool holder 252 is configured to be mounted on the tool carrier 30 conventionally, without using the quick-clamping device according to the invention.

The second and third exemplary embodiments show that it is optionally possible to mount both tool holders 32 taking a form according to the invention, using the quick-clamping device according to the invention, and also tool holders 232, 252 of conventional form, using a conventional screw arrangement, on the tool carrier 30 formed according to the invention.

1. A tool carrier of a machine tool, including a tool holder carrier with a receptacle that extends into the tool holder carrier and into which a fixing body of a tool holder is configured to be inserted, by moving it in an insertion direction, and immobilised in an inserted condition by fixing it in the receptacle by a positively locking element,
the positively locking element is a fixing wedge-shaped body that is movable within the tool holder carrier, in a direction of movement transverse to the insertion direction, between a release position and a fixing position, and in that, in the fixing position, the fixing wedge-shaped body cooperates with a wedge receptacle of the fixing body.

2. A tool carrier according to claim 1, wherein the fixing wedge-shaped body is movable linearly in the tool holder carrier and acts on a wedge surface of the wedge receptacle of the fixing body by means of a fixing wedge surface.

3. A tool carrier according to claim 1, wherein the fixing wedge-shaped body is movably guided in a guide channel in the tool holder carrier.

4. A tool carrier according to claim 3, wherein the guide channel engages in the receptacle transversely to the insertion direction.

5. A tool carrier according to claim 1, wherein the fixing wedge-shaped body has, on a side opposite the fixing wedge surface, a support surface by means of which it is guided such that it is supported in the guide channel, at least in the fixing position.

6. A tool carrier according to claim 5, wherein, in the fixing position, the fixing wedge-shaped body is supported in the guide channel by its support surface on both sides of the receptacle.

7. A tool carrier according to claim 2, wherein the fixing wedge surface of the fixing wedge-shaped body extends in a plane that forms an acute angle with a guide direction of the fixing wedge-shaped body that is movable in the guide channel.

8. A tool carrier according to claim 1, wherein the fixing wedge-shaped body is movable between the fixing position and the release position by a positioning unit and is positionable both in the fixing position and in the release position by means of the positioning unit.

9. A tool carrier according to claim 8, characterised in that the positioning unit is arranged on the tool holder carrier on a side remote from a front side of the tool holder carrier that faces the workpiece.

10. A tool carrier according to claim 8, wherein the positioning unit is manually actuable for the purpose of moving the fixing wedge-shaped body between the fixing position and the release position and for the purpose of immobilising the fixing body in the fixing position.

11. A tool carrier according to claim 8, wherein the positioning unit has a bayonet structure by means of which the fixing wedge-shaped body is positionable in both the fixing position and the release position.

12. A tool carrier according to claim 11, wherein the positioning unit has a flanged body with bayonet flanges that cooperate with a bayonet contour of a guide sleeve.

13. A tool carrier according to claim 12, wherein the bayonet contour has two support surfaces that are spaced from one another in a displacement direction and rotated by an angle in relation to one another about an axis parallel to the displacement direction.

14. A tool carrier according to claim 12, wherein the flanged body with the bayonet flanges is connected to a centring body that is guided in the guide sleeve, displaceably in the displacement direction.

15. A tool carrier according to claim 1, wherein the fixing wedge-shaped body is coupled adjustably to the positioning unit, in particular to the centring body.

16. A tool carrier according to claim 15, wherein the centring body is coupled to the fixing wedge-shaped body by means of an adjusting screw that is screwed to the centring body.

17. A tool carrier according to claim 1, wherein the tool holder carrier has a bearing side on which the tool holder is placeable.

18. A tool carrier according to claim 17, wherein the tool holder carrier is provided on the bearing side with first positively locking elements that extend in particular transversely to a feed direction of the tool holder carrier.

19. A tool holder for fixing to a tool carrier, wherein the tool holder has a fixing body that is insertable into the receptacle of the tool carrier.

20. A tool holder according to claim 19, wherein the fixing body, as the wedge receptacle, has an aperture in which there is provided a wedge surface on which a fixing wedge-shaped body of the tool carrier acts in the fixing position by means of its fixing wedge surface.

21. A tool holder according to claim 19, wherein it has a support body that is placeable on the bearing side of the tool holder carrier by means of a support surface.

22. A tool holder according to claim 19, wherein, starting from the support side of the support body, the fixing body extends away from the support body.

23. A tool holder according to claim 19, wherein the support body is provided, on the support side, with second positively locking elements that engage with first positively locking elements of the tool holder carrier when the tool holder is fixed to the tool holder carrier.

24. A tool holder according to claim 23, wherein the second positively locking elements, in cooperation with the first positively locking elements, exactly position the tool holder in relation to the tool holder carrier in a feed direction of the tool carrier.

25. A tool holder according to claim 19, wherein the fixing body has a greater extent in a direction transverse to a direction of movement of the fixing wedge-shaped body than in the direction of movement.
